(19) United States
(12) Patent Application Publication
(10) Pub. No.: US 2007/0198505 A1
(43) Pub. Date: Aug. 23, 2007

(54) Context-based search engine residing on a network

(75) Inventor: Napier S. Fuller, Belmont, CA (US)

Correspondence Address: HINCKLEY, ALLEN & SNYDER, LLP, 43 NORTH MAIN STREET, CONCORD, NH, 03301, US

(73) Assignee: PANTHAEN INFORMATICS, INC., San Carlos, CA (US)

(21) Appl. No.: 11/572,595

(22) PCT Filed: Jul. 25, 2005
(86) PCT No.: PCT/US05/26139

§ 371 Date: Jan. 24, 2007

Related U.S. Application Data
(60) Provisional application No. 60/591,698, filed on Jul. 26, 2004.

(51) Int. Cl. G06F 7/00

(52) U.S. Cl. 707/5

(57) ABSTRACT

This invention provides a context-aware search engine that communicates with users having a particular location at a particular time within a tessellated network of geographically spaced-apart communication nodes, typically wireless nodes/access points (APs). Based upon the user's location and time, the search engine delivers relevant site-specific information germane to that user's place and time. In an illustrative embodiment, the search engine correlates the address of the node within which the user is located when making a query to the engine via a wireless device such as a laptop computer, PDA or cellular telephone. The time of the query is also accounted for. The query causes the search engine to focus its database search (from a large array of information resources indexed by the search engine and accessible thereby) on those informational items/web sites that fit the appropriate place and time of the user. In particular wireless nodes are viewed as spatial aggregation units (such as polygons) of demarcation in an urban or other densely settled environment (e.g. a university campus, institution, etc.) to identify and characterize the physical environment of the information-seeker.

### BACKGROUND OF THE INVENTION

1. Field of the Invention

The present invention relates to search engines and more particularly to search engines that employ context-based limitations to filter returned search results.

2. Background Information

Context-Aware Computer Systems

“Contextere” is a Latin verb meaning “to weave together.” When people speak to one another in person, the communication exchange is rich in implicit messages: body language and eye contact. Moreover, the physical environment-a crowded subway car or a private office—has innate characteristics that implicitly guide the thoughts and conversations that occur within that particular architectural space. The act of information-seeking starts with an internal conversation involving context. By looking carefully at the information seeker's context during the act of information seeking, one can gain cues to help filter information.

If one views the ecology of information in the Internet (accessed by information-seekers typically via the World Wide Web (also termed simply, the “web”) directory structure) as an infinite extension of our own mental capacity for recollection of data, the problem quickly shifts to finding the data one needs. The vast data available on the Internet affords the client a large amount of new information; yet one's ability to understand patterns and to connect information with one's environment is not augmented in tandem. The present invention thus aims at providing the client information germane to a given spatial/temporal context to allow immediate interpretation and decision-making with minimum ambiguity. The goal is not to utilize the web to look for obscure data, but rather to utilize the web to provide data that could be used in one's immediate context to help make every-day decisions. Hence, there is an overall view to offer data in logical groupings so that decisions that require comparison or multiple variables can quickly be made.

A paper page contains text which has been created by an author in the past and which is read by an individual in the present. Hence, the relationship between the author and the reader is one of estrangement as they are separated in both time and place: a text is always removed from its original context. Nowhere is this separation more acute than within the Web. The author's audience is largely unknowable—a reader of a web page could theoretically speak any language, live in any country, and be of any age.

Since there is no defined simulacrum of “reader,” there is no conversational exchange as the very idea of “context” has been completely eroded. As the structure of the web permits an increasingly diverse audience, this “unknowability” has become problematic in information exchange. A technique that allows mimicry of the aspects of common sense reasoning that underpins vernacular spoken exchanges is highly desirable; since common sense is by its nature implicitly understood by both parties in a conversation, what is needed is a search approach that would be able to automatically offer content germane to the physical setting and likely intent of the information seeker.

Conventional Search Techniques

The act of seeking for information on the web is now among the most frequent activities in the field of human-computer. One can view the web as a mass of information, and there are several instruments presently available to help one navigate the web: search engines, portals that categorize websites by type, and expert lists.

Conventional, publicly available search engines such as Google and AskJeeves attempt to provide hyperlinks (or “hits”) to web pages based upon a user's explicitly entered search terms (or “query”). A query is typically a series of words such as, “Montreal tourism official.” This type of search process requires two conditions. First, the search engine must contain a corpus of metadata about the content (i.e., text) of each of the billions of web pages on the Internet. Second, the user must be able to elucidate his intentions in terms a few key words (i.e., text) to form the query that starts the search engine.

In other words, search engines are not particularly useful if the information seeker does not already have a clearly established goal that can be elucidated succinctly in text input. For example, search engines may quickly lead a user to Montreal's official website, but search engines cannot yet suggest enjoyable activities on a Thursday night once one arrives in Montreal. This is because, in part, conventional search engines do not harness the user's context: an essential element to many site-specific seeking tasks.

Another way the web is navigated is via portals that attempt to categorize the entire web such as Yahoo's web directory or niche sites like FirstGov.gov (“the US Government's Official Web Portal”) that attempt to organize a specific part on the web for easy access. Both sites are edited and seek to impose a logical tree structure that can be helpful by offering the user a series of choices. This approach is helpful to information-seekers that have somewhat ambiguous goals or incomplete knowledge of a subject. However, this approach can be laborious as the information-seeker must read through many web pages, and make many choices before finding the information sought. One could view this sort of information-seeking paradigm as “information via structure.”

Yet another way the web is navigated is via “expert” lists: a set of information edited by a person or persons deemed to be highly qualified to offer advice on a given subject. One such website is About.com, an online encyclopedia. Such sites can quickly provide quality information and links that the user can visit germane to the query. For example, About.com offers a brief definition of the term, “real number,” with a definition that includes links to like terms-rational number, integer and whole number-making it easy to quickly move laterally or to continue to drill down into more elaborate definitions. The goal is to allow the user to make the best choice by creating an information environment suitable for quick comparisons; one could view this last information paradigm as “information via quality.”

However, studies of the Internet usage patterns by Hubermann indicate the querent has a clear preference for information that can be found very quickly; typically sites that can offer the querent useful information within 3 clicks of the mouse are much more likely to be visited on a repeat basis when compared with sites that are more difficult to navigate. In other words, the success of a search engine, portal, or expert list is closely related to its ability to quickly provide the querent information on a repetitive basis. Time is a currency on the Internet, and every fraction of a second counts.

Hubermann's research is important to understanding why Internet usage in mobile telephones has been generally regarded as a failure at present; initial predictions that people would utilize their mobile phones to access the Web in the same manner as they do from desktop computers have so far proven false. With a limited screen size to display websites along with a smaller numerical keyboard with which to make queries, it is not surprising that significant barriers to finding information exist in a mobile environment.

Moreover, the behavioral environment of a mobile user is one that is particularly germane to temporal context. For example, people don't ordinarily do patent art research on a mobile telephone; that is what they do at the office where they can take notes and print out documents. The information-seeking environment of the mobile user is one where behavioral context and temporal decision-making are especially important. On a broader scale, could search engines be viewed as mechanisms for an “information push” paradigm in which the tables are turned and the information searches for the client via his metadata profile without invasion of individual privacy? Yes, and such is the focus of the present invention.

Geography and Choice Theory

The present invention was influenced by related art from a number of fields: geographic information systems (“GIS”), spatial statistics, and choice theory. The “spatial aggregation unit,” a concept utilized in GIS modeling, is a polygon of physical space—such as a building, a ZIP code, a land parcel, a river, or a county—that is represented in a database as an entity having a set of attributes. GIS software applications are able to utilize spatial aggregation units, for example ZIP codes, in an entity-attribute relational database model to represent demographic information as a function of space.

The field of spatial statistics is concerned with analysis and probability of events that occur in a geographic context. For example, during the United Kingdom's culling of livestock during the “Mad CoW” epidemic, spatial statistics were used to create the geographical models of vector transmission as a function of time. These models were then used to delegate resources in a best practice manner to stop the spread of the infection. The present invention utilizes some of these techniques to predict information-seeking patterns as a function of time and space.

Location-based applications can be, in general, far simpler than context-aware applications that are based upon assumptions and human intent in addition to location. Strictly speaking, location-based services do not draw from artificial intelligence but are rather more straightforward in their architecture. In general, context-aware applications are designed with great attention to the user's behavioral intentions and immediate set of options.

In developing the mechanism used to create a new approach to searching for web content, two approaches to establish the ‘common sense meaning’ of our environment should be considered. “Common sense” is not a simple thing. Instead it is an “immense society of hard-earned practical ideas—of multitudes of life—learned rules and exceptions, dispositions and tendencies, balances and checks.” (Marvin Minsky, The Emotion Machine, draft version, 2005). One key approach to elucidate “common sense” is the Society of the Mind theory by Minsky that manifests itself as the OpenMind project by his student, Push Singh, at MIT (available on the World Wide Web at http://commonsense.media.mit.edu). The OpenMind project collects and organizes large data sets of simple propositions such as, “the sky is blue during the day.”

The most successful efforts to structure our spoken language is Lenant and Guha's Cyc (pronounced “psyche”) markup language that provides a grammar for the unspoken cognitive context that underpins spoken exchanges. Cyc, which according to its website is “the leading supplier of formalized common sense,” is funded in part by the Pentagon's Defense Advanced Research Projects Agency. Lenant's work originated from his desire to create a processing system to enable common sense knowledge related to natural language processing (NPL) to be represented. Cycorp determined that there are roughly 12 separate dimensions to spoken conversations. By describing the context of a conversation in such a vector, it becomes possible to “virtually lift” assertions from one context to another. Once a context can be adequately described, it becomes possible to reason based upon assumptions: to fit pieces of a puzzle together.

While Cycorp's “ontological engineering” has resulted in a sophisticated calculus to represent spoken exchanges, the problem of the shared context of physical space is more elementary-thereby requiring fewer dimensions and greater simplicity than in Cyc. What is desired in a context profile is a description akin to the artist's quick sketch of a landscape, taking in both the visual reality of a space (its appearance and purpose) and the psychological character. Again, the emphasis is on impressions—trying to represent the essence of a physical place in a few quick marks.

In any case, it is highly desirable to provide a way for users to more efficiently and accurately focus in on certain often-needed and context/time sensitive information so that it can be obtained using a variety of currently available portable and/or wireless information devices, such as laptop computers, cellular telephones, personal digital assistants (PDAs), and the like. In this manner, such devices can be used more fully to their specified capabilities without overly inconveniencing the user in so doing.

### SUMMARY OF THE INVENTION

This invention overcomes disadvantages of the prior art by providing a context-aware search engine that communicates with users having a particular location at a particular time within a tessellated network of geographically spaced-apart communication nodes (that define spatial aggregation units from a plurality of such units in an “urban” setting), typically wireless nodes/access points (APs). Based upon the user's location and time, the search engine delivers relevant site-specific information germane to that user's place and time. In an illustrative embodiment, the search engine correlates the address of the node within which the user is located when making a query to the engine via a wireless device such as a laptop computer, PDA or cellular telephone. The time of the query is also accounted for. The query causes the search engine to focus its database search (from a large array of information resources indexed by the search engine and accessible thereby) on those informational items/web sites that fit the appropriate place and time of the user. In particular wireless nodes are viewed as spatial aggregation units (such as polygons) of demarcation in an urban or other densely settled environment (e.g. a university campus, institution, etc.) to identify and characterize the physical environment of the information-seeker.

In an illustrative embodiment, a database containing context profile data and a plurality of client intent vectors as a function of time associated with events is provided in a context-aware server interconnected with the wireless network. Also provided is a database including “urban” or locational context profile data representing the list of all possible events. The vectors of possible events and the vectors of client intent are summed to create high score matches and low score matches. The high score matches are displayed to the client according to a hierarchy that can include a number of logical orderings, such as listings of several events of the same type, listings of events at or near the same location or events occurring at certain times, now and in the future. The corpus of information blocks representing events is typically so large that one or more filters are applied in pre-process states to expedite the operations by first removing information blocks that are clearly not applicable to the given context of the client. The resulting lists of events are displayed in association with links to relevant web pages for the events and, where desirable, interrelated information and links (such as public transportation schedules, etc.).

### BRIEF DESCRIPTION OF THE DRAWINGS

The invention description below refers to the accompanying drawings, of which:

FIG. 1 is a block diagram of a context-aware search engine environment according to an illustrative embodiment of this invention;

FIG. 1A is a schematic diagram of an exemplary client device for communicating with the context-aware search engine of FIG. 1;

FIG. 2 is a block diagram of an exemplary mapping between locational tessellations and database entries for the search engine of FIG. 1;

FIG. 3 is a block diagram of an exemplary relationship between informational events in a relational database and the memory of the context-aware server according to an illustrative embodiment;

FIG. 4 is a diagram showing a process for filtering events from a larger corpus stored in the memory of the context-aware server containing possible events; and

FIG. 5 is a diagram showing a process for structuring high-ranking informational events to maximize the decision-making process of a client.

### DETAILED DESCRIPTION OF AN ILLUSTRATIVE EMBODIMENT

Theory of Operation

The present invention draws from the field of cognitive science as a basis for modeling situational awareness in order to simplify frequent information seeking tasks. The present invention aims to be an “intelligent” application and seeks to produce web content that reflects the common sense of a given physical environment at a particular time. For example, the illustrative embodiment applies a standard common sense proposition, such as, “students have more free time on the weekend than during the week.” Drawing, for example, from the work of Marvin Minsky and Push Singh in Common Sense Computing at MIT, a number of propositions can be made related to place and time at the AP spatial granularity. In such ways, the present embodiment of the invention acts to both cast away information on the web that is extraneous to the client's situation but moreover the invention acts to help the client find useful information related to the present situation.

According to an illustrative embodiment, this invention provides a framework to capture, encode, and interpret context-aware cues about people's anticipated information needs as a function of site-specific urban space at a given time. When human-computer information exchanges reflect the behavioral context of a particular setting, a client saves time and is better able to make decisions in the field. The framework provides a context-aware web server that focuses upon defining the client's short-term possibilities—the web server's content, thus, becomes context-aware. A multi-dimensional attribute model is presented to track the context of each wireless access point's surroundings in a wide area network; this attribute model is also used to structure events in order to match them with a particular context. “Events” shall mean “situational information” in the present context of the invention's illustrative embodiment; for example an event may be information relating to what's playing at the neaby movie theatre or a link to a website germane to particular setting such as a online dictionary to a university campus. The overall framework of the invention consists of three separate parts: the client's browser application (front-end), the context-aware profiles of data derived from the client's location and information (middle-ware), and the subsequent content offered by the intranet server (the back-end).

The communication between a client and the web often breaks down because of the failure of the latter to recognize context. Often the problem in mining place/time data is that there are no clear formulas of how variables fit together: just pieces of isolated data such as an address, hours of operation, and event information. It takes time and skill to make an analysis of the information on a screen, especially when information is often displayed in separate sites that force the client to rely upon short-term memory or shorthand notes in order to make a decision that requires comparisons. The present invention creates a way to impose logic upon a horizontal and vertical axis to create a tree of multivariate data that is germane to a particular information-seeking situation. A horizontal axis of data can be viewed as a series of choices in which the client will choose one item out of set of like items (for example tourism activities in Manhattan on a Tuesday night: films, Broadway, off-Broadway, comedy shows, etc.) whereas a vertical axis of data is akin to a second-order of dependant variables (for example: price, directions via public transit, starting time, reviews). The overall idea of the present invention is deliver information germane to the user's context.

Since there is no existing method of implicitly modeling context on the web, narrowing down site-specific data sets in very laborious as the client must often enter contextual information (for example what day it is) into each website. The client quickly learns to avoid making such inquiries in the first place as the task of searching for the right amount of data to make a decision can be quite irksome. Yet broad and unspecific queries could indeed be answered by an intranet server that was designed to handle common-sense reasoning about the client's context and the surrounding environment's set of events.

The barrier to the flow of site-specific information from the client's perspective is not connected with the speed of the network, but rather the time it takes for the user to cognitively process the large quantity of data and then to sift until only the desired data remains. This threshold of effort is high enough to render some data-seeking activities worthless as its capture has a higher opportunity cost than its utility. A “middle-ware bucket” of context cues can be used both to save the client time by filtering out information that does not apply to the client's situation and also to provide utility by reducing the need for explicit input (clicking and typing) in repetitive information-seeking tasks that one finds in one's day-to-day decision-making in a short term time frame. The present invention aims to help us make short term decisions in a “hour-to-hour” time frame in a mobile setting by offering key granules of information as a king of catalyst to help one make decisions by offering a menus of available options. The present invention's goals are not lofty, but mundane—helping us get information about public transport schedules in the “now” within one click of the mouse or suggesting options of fun things to do on a Friday night in a city we are visiting. These goals are achievable by structuring metadata about both the client's situation (akin to information “pull”) and the set of information germane to that type of situation (akin to information “push”).

The overall questions regarding the present invention are: “What role can a network's infrastructure and geographical makeup play in helping to discern site-specific behavioral patterns of client's information seeking patterns? How can a network infrastructure become a tool to add commonsense models that relate to a heterogeneous urban space?” The bifurcation between the client and the server-the front-end and the back end—appears iconic in computer science. The present invention relies on harnessing and describing the middle ground—the physical transmission media of air and wires. The present invention detects the context of the client by looking carefully at the location of the nodes of physical transmission and making inferences about each unique locale.

According to illustrative embodiments of this invention, the Middle-Ware (or “Context-Engine”) produces, within a fraction of a second, a computer generated representation-a snapshot of the client's present context—by combining objective data (place and time attributes) with subjective data (behavioral assumptions, preference patterns, and pre-existing cognitive knowledge) to produce common-sense rules a “context-aware profile” that is designed to provide a grammar for the present invention, a server, to interpret. The intranet server is specially designed for information-seeking regarding the clients' environmental character within a specific WAN, and with certain modifications can be made to produce web content germane to the client's situational decision-making.

The invention provides a method to capture and process context-aware cues in a wireless network to better filter and present information to a client in a mobile setting. Steps of the method include building an entity-attribute model in a relational database of wireless tessellations, i.e., the physical cloud that corresponds with the range of a particular wireless access point. This entity is composed of two attribute parts: first order “atomic data” that is passed off to a database on the server-side where logic-based rules based rules are executed. This database also contains attributes “subjective” metrics of client-context. The objective propositions are related to the client's activity landscape as a function of cyclical time patterns only; the phrase, “activity landscape” refers to the client's short-term possibilities for a change of activity. Objective data is derived from tables in a many:many relationship and would include for example such variables as transportation tables of the client's nearest node of departure as well as data relating to operating hours.

The subjective propositions represent “fuzzy” patterns involving site-specific behavioral expectations and preference associations. These dimensions offer hints as to the client's likely shift from one activity to another over the next few hours. What new data will be required/suggested to assist in decision-making? Is the client busy or likely to have free time? How can “when and where” you are reveal clues as to one's likely. short-term intent? Hence logic-based propositions are related to common sense reasoning; logic-based rules are created to indicate preference patterns as a function of the client's place and time.

Description of an Illustrative Implementation of the System

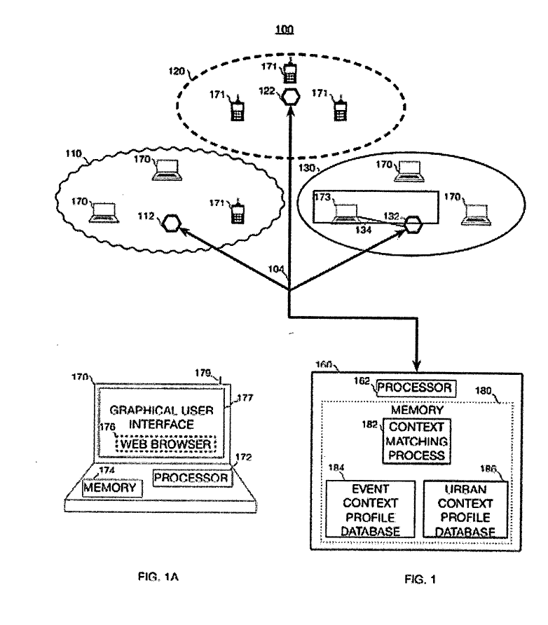

FIG. 1 details an exemplary system 100 in which the teachings of the present invention can be implemented. The system 100 includes multiple client devices (for example laptop computers 170 and cellular telephones 171), each containing a processor 172, memory 174, and a web browser 176 running on the device (see FIG. 1A). A network interface 179 is also provided. Here it is a wireless interface operating on, for example, a conventional “WiFi” communication protocol, such as one adopted under IEEE Standard 802.11. The system in this simplified example details three adjoining physical spaces 110, 120 and 130. Each physical space is served by a respective wireless access point (also termed “AP” herein) 112, 122 and 132. The system 100 also includes a network 104 that may be, for example, the well-known Internet or a Wide Area Network (WAN) or Local Area Network (LAN), or a combination of these, among other types of networks. Each access point 112, 122 and 132 is connected by an appropriate link (optical, wired and/or wireless) to the network 104. Each exemplary physical space contains (and each AP communicates with) multiple client devices 170, 171 that are, at least temporarily located in that space. The range of the AP essentially defines the boundary of the given space. While good wireless network design usually dictates some overlap in communication range between adjoining APs, at any given time conventional wireless networking techniques arbitrate which device “belongs” to which access point (based upon relative signal strength, etc.).

Some devices 173 may be connected by a wired/physical connection 134 to the given AP (132). Such devices are treated as within the space served by that AP 130.

Users generally operate client devices 170, 171 and 173 over the network 104 to communicate with each other and may also communicate to systems coupled to the network 104. In particular, one connected system is the context-aware information server 160 according to an illustrative embodiment of this invention. A user may access this server by a number of known techniques, generally implemented via the web browser 176 associated with that client's device. The browser 176 features a mechanism for entering and viewing data, such as a conventional graphical user interface (GUI) 177 that can be based upon standard hypertext markup language (HTML) commands received from the server 160 or another computer in the network. This server 160 is accessed particularly to obtain location and time-context-aware information on a particular topic of interest to the client. In one example, a client initiates a context-aware web search using a “get” command sent from the client device 170 to the access point 112 and through the network 104 and then to the context-aware server 160. A variety of secure and/or non-secure communication protocols can be employed to conduct communication via the network. Overlying such protocols is typically a well-known network protocol, such as TCP/IP.

The context-aware server 160 may be a standalone computer or group of interconnected computers including a processor 162 coupled to a computer readable memory 180. The server 160 may additionally include, or be linked to, a computer program for conducting a context-aware search process 182 (also termed a “search engine”). This type of search consists, for example, of a matching process that identifies the temporal and locational context of the client and matches this with appropriate items from a listing of items associated with relevant places and times. The search process 182 may include secondary elements such as a plurality of databases, for example databases 184 and 186, which contain contextual profiles in an entity-attribute model. In the illustrative embodiment, the urban context profile database 186 defines cues about particular tessellations of physical spaces in time and correspond to particular physical spaces such as 110, 120 or 130 in a defined network 104. This search process 182 may include or be linked to yet another database 184 containing event information with contextual cues in an entity-attribute model.

By way of an operational example, a client using a device 171 makes a wireless connection with access point 122 and is thus considered to be within space 120 which, in turn, has a pre-existing context profile in the urban context profile database 186. The context-aware search process 182 filters information from the event database 184 based upon the context cues gained from the urban context database 186 germane to the client's present physical location. The search process 182 then generates a hierarchy of best matches of event information for a given urban context, and disseminates this data in the network 104 to the client's device 170, for example in an HTML format for the client's browser 176. A more-detailed description of the functionality of this process will be described below.

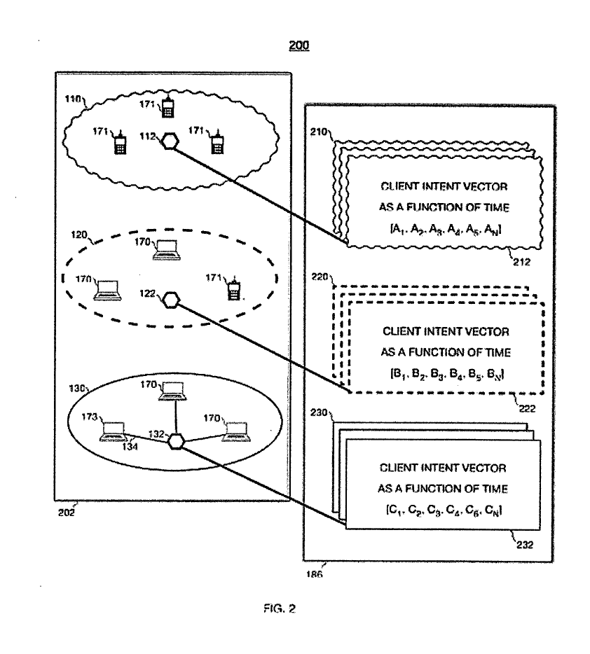

FIG. 2 is a diagram illustrating an exemplary mapping 200 between tessellations and database entries in the system 100. As described above, the system 100 includes multiple physical tessellations 202 of space 110, 120, and 130 each of which contains an access point respectively within its bounds 112, 122, and 132 in a network 104. As noted above, for an access point 112, 122, 132 there is only one corresponding physical space tessellation 110, 120, 130. Each physical tessellation 110, 120, 130, in turn, corresponds to only one intent model 210, 220, 230 in the above-described profile modeling database 186. Each intent model 210, 220, 230, in turn, has a plurality of intent vectors 212, 222, 232 as a function of time stored in the database 186. Each vector 212, 222, 232 is composed of both atomic data that does not change in time, for example, the location of the physical tessellation, but also a series of variables (respectively denoted A₁-A_{N}, B₁-B_{N}, C₁-C_{N}) that represent a contextual estimate of the client's informational needs as a “pull” via a mathematical vector weighted scores representing intentions or a possibility to engage in a certain type of activities.

By way of example, a contextual estimate of a client's informational needs would postulate that a client in downtown Washington, DC (or tessellation A) on Monday, July 4, 2005 would not be likely to be engaging in a work activity at 10:00 AM since it is a national holiday, but a client in Montreal, Canada would likely receive a high score for work activity since that same day is a workday in that locale (or tessellation B). Thus it could be represented in these vectors that the client in Washington, DC would on average be more interested in engaging in a recreational activity (and seek information to that end) during this specific weekday morning than a client in Montreal being the differences in situational context.

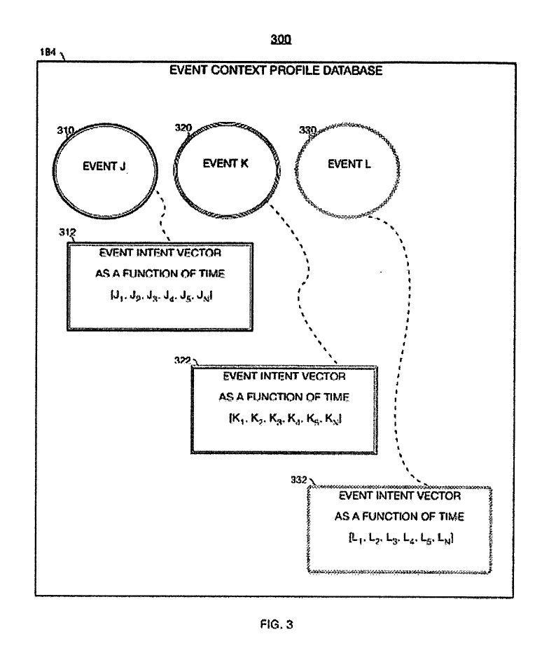

FIG. 3 illustrates the relationship 300 between an informational event 310, 320 and 330 which is stored in the relational database 184 in the memory 180 of the context-aware server 160. Each event 310 in turn corresponds to an event intent vector 312. Similar to the description for FIG. 2 above, each intent vector 312, 322, 332 contains both fixed data-such as a name, location, HTML link, and hours of operation-and also a series of variables (respectively denoted J₁-J_{N}, K₁-K_{N}, L₁-L_{N}) that represent a contextual estimate of the event information's “push” value via a vector of similar structure and semantics as that used for the “pull” vector 210, 220 and 230 (FIG. 2). The goal is to create pieces of the puzzle to fit together.

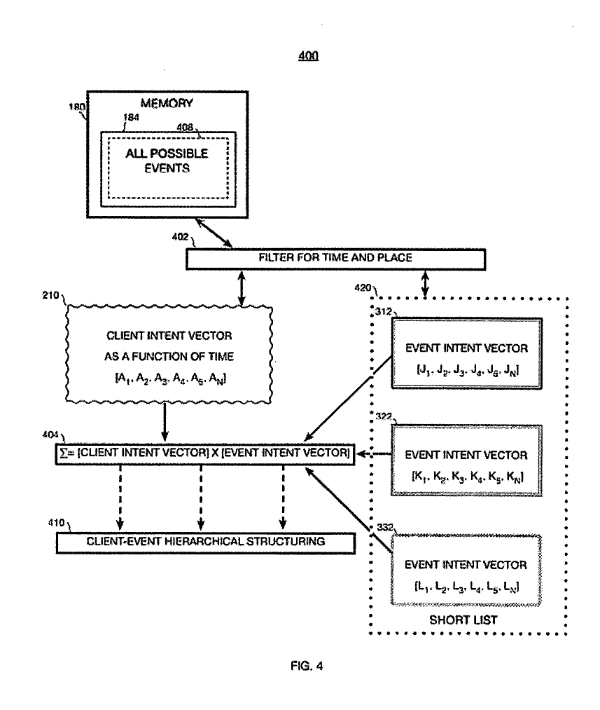

FIG. 4 details the process 400 of filtering-out events from a larger corpus of all possible events 408 stored in the server's memory 180 being a database 184 of the context-aware server 160. In this embodiment, a filter 402 for both time and place is employed. The goal of the filter 402 and corresponding filtering process is to efficiently remove many events that are not germane whatsoever to the client's place and time as defined in the client's context profile 210 at a given time. Once a shortlist 420 of informational events from a larger corpus 408 in the database 184 has been established by the algorithms of the matching process 402, this shortlist will be stored in memory 180, and another more-complex comparison will be made between the client's context profile 210 and the shortlist of information events 420 for further refinement. Each informational event 312, 322, 332 in the shortlist 420 will be compared via its vector of the “push” force in a plurality of variables with the corresponding vector for the “pull” force of each client profile 210. This comparison 404 will be made via a mathematical formula involving the adding of one vector to another and then taking the sum of the sequence of variables.

The system's logic can be illustrated, for example, by using an abridged version of the client/event vectors; these vectors represent the preference associations along a certain dimension. A university campus is used for the example below to illustrate this idea of showing a normalized example of both a close match between event and client and then a poor match between event and client context:

| | client intent vector | | info event intent vector |
|---|---|---|---|
| Σₛₐᵤ_{_{—}}id:event_{_{—}}id = | ([a₁, z₂, z₃, a₄, a₅, aₙ] | × | [b₁, b₂, b₃, b₄, b₅, bₙ]) |
| | a residential dorm (client) | × | a film svreening (event) |

| Time '2 Saturday Morning on University Campus | |
|---|---|
| academic—a connection with computer science | [2 × 0] = 0 |
| break—a need for a change of activity | [5 × 8] = 40 |
| excursion—the viability of a journey off-campus | [9 × 8] = 72 |
| residential—a connection with living space | [8 × 0] = 0 |
| social—a venue for meeting others casualty | [5 × 5] = 25 |
| Total | 137 high |

| | | |
|---|---|---|
| E66, a residential dorm | × | Digital Narrative Lecture |

| academic—a connection with computer science | [2 × 9] = 18 |
|---|---|
| break—a need for a change of activity | [5 × 1] = 5 |
| excursion—the viability of a journey off-campus | [9 × 0] = 0 |
| residential—a conneection with living space | [8 × 0] = 0 |
| social—a venue for meeting others casually | [5 × 3] = 15 |
| Total | 38 low |

From the above individual scores (10 being a high preference and 0 being a low preference) the Digital Narrative Course—being taught on a Saturday morning-would not fit with the client's context; the context-aware server will thus likely, “give the event a miss,” in terms of displaying this event on the front page. The client is expected to be more inclined to take a break off-campus and to engage in an activity that is more social and less academic on Saturday. Conversely, if the event was held during the week, or if the location of inquiry was a computer science facility, this event would receive a much higher score as the client's preference profile shifts as a function of cyclical time and place. The context-aware server is thus more likely to suggest the first choice of seeing a film by displaying this choice on its front page “real estate” of likely events to interest the client.

The short list of events that are retained for a specific client context are then sorted from greatest to least via the Σ_{sau:event}_{_{—}}_{id} value. A final step is the client-event hierarchical structuring process 410 which sorts the events into a client-viewable frame that is categorized by type. For example, the informational events could be sorted by time of occurrence: “now,” +30 minutes, and +90 minutes for a matrix of slots in an HTML web page on the client's device. An exemplary structure for such a display is as follows:

| | Type I “now” | Type II “soon” | Type III “ahead” |
|---|---|---|---|
| occurs in: | 0-30 minutes | 30-90 minutes | >90 minutes |
| on homepage: | ×4 1^{st} choices | ×4 1^{st} choices | ×4 1^{st} choices |
| on linked page: | ×16 2^{nd} choices | ×16 2^{nd} choices | ×16 2^{nd} choices |

A variety of well-known web page formats, link structures and display modes can be employed to deliver the content of the event listing. These display formats should be within the ken of those skilled in the art.

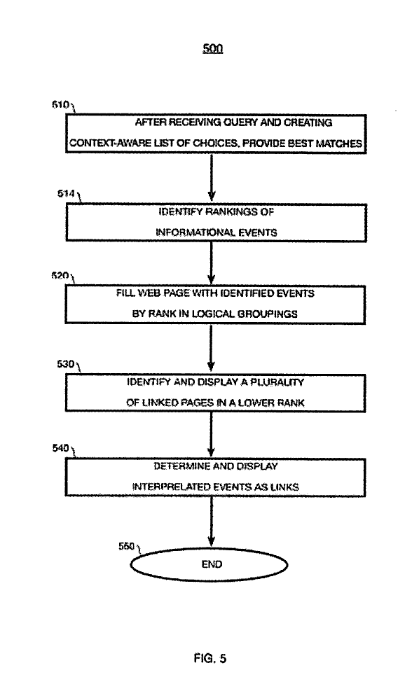

FIG. 5 is a diagram that illustrates the final process 500 of structuring the high-ranking informational events to maximize the decision-making process of the client. The goal is to fill the frame of a web page in a coherent structure based upon sets of choices. The procedure initiates after receiving a query from the client and processing it in accordance with the vector process above (step 510). The highest ranking informational events are identified by the server process and ordered accordingly (step 514). These events fill a webpage in accordance with logical groups of choices 520 base upon similarity of events, time, location and/or other criteria. Such criteria can be created as needed form a predetermined list of criteria or from other intelligent processes that review related events and extract a common property from them. For example, if there was a critical mass of lunch options for a given client context, a category of “lunch options nearby” would be created. In general the lunch events were previously identified by the system and its administrators/programmers as part of a “lunch options” category and an appropriate flag was placed in association with each URL in the system's directory that would serve lunch within the time and place of the user's query. Thus, because a predetermined number of event entries having the lunch flag were identified in this particular context (location), a lunch option category was displayed to the user on the device browser screen. The goal is to structure the data based upon the client's need of choices whereas the client is given a series of topics with a list of options. This structuring of the data is akin to a menu and has a goal of reducing the cognitive load upon the client. The context-aware portal would include a plurality of linked web pages (step 530) with lower ranking informational events described not on the front page, but on linked pages produced by the context-aware server. Notably, informational events are interrelated in a vertical context (step 540) meaning for example, that if one selected the “hit” for a particular lunch venue from a list of choices, more information about the event in question would be displayed along with supporting events, for example public transportation to the lunch venue. In general, the interrelation of events is performed by the system administrators and programmers having innate knowledge of the items that the class of clients would want to see. A series of links can be established in an appropriate directory to interrelate selected events to others. Thus, a link to car rental agencies or limousine services would not likely be included as transportation for students to the lunch venues. The process ends at step 550 with a complete web page(s).

A significant goal of the system is, thus, achieved in that the client has been provided with information having an emphasis upon a “push” process in which the germane informational events “find” the client without the client having to formally input data about his goal. Once the client is offered a set of options applicable to his context, he may “drill down” to find out more information.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, although the preceding description generally discussed the operation of search engine in the context of wireless use of the Internet, a context-aware information dissemination system as described above could be implemented in other systems for example, a context-aware navigation system. Moreover, while a series of acts have been presented with respect to FIGS. 1-5, the order of the acts may be different in other implementations consistent with the present invention. Similarly, the organization of databases and associated tables and listings as well as techniques for associating data sets are all highly variable. Accordingly, this description is meant to be taken only by way of example, and not to otherwise limit the scope of the invention.

What is claimed is:

1. A method of generating context-aware information based on a search query issued by a client having a device comprising the steps of:
identifying a present spatial aggregation unit of a plurality of spatial aggregation units and a relative time in which the device delivers the search query;
obtaining a corpus of information blocks each having a context relevant to the client's context and also relevant to the spatial aggregation unit and the relative time;
assigning relevance scores to the corpus of information blocks based upon similarity between the context of the information blocks and the context of the client's present spatial aggregation unit and the relative time; and
sorting the information blocks based on the assigned relevance scores.

2. The method of claim 1 further comprising applying one or more filters to the corpus of information blocks in pre-process states to expedite the operations by first removing information blocks that are clearly not applicable to the given context of the client.

3. The method of claim 1 further comprising displaying on a browser of the device a listing of the information blocks according to a predetermined logical ordering and based upon a ranking associated with the relevance scores.

4. The method of claim 3 wherein the step of displaying includes linking relevant web sites associated with at least one of the information blocks.

5. The method of claim 1 wherein the step of displaying includes associating interrelated information blocks and listing the information blocks.

6. The method of claim 1 wherein the step of assigning includes summing vectors associated with the context of the client's present spatial aggregation unit and the relative time with vectors associated with each of the information blocks.

7. A method for representing physical space based upon a representation of the “pull” force of segmented polygons that correspond to a network wireless cells comprising the steps of:
obtaining a model of a pattern of human behaviors and intentions within a given one of the cells as a function of time; and
forming a data type and syntax comprising (a) static data and (b) a uniform vector of one or more variables that represent a corpus of the cells in terms of behavioral intent as a function of time.

8. The method of claim 1 further comprising representing information blocks based upon the “push” pattern of human behaviors and intentions associated with each block, and including the steps of:
obtaining a model of the pattern of human behaviors and intentions within a given cell as a function of time; and
forming a data type and syntax comprising (a) static data and (b) uniform vector of one or more variables that represent the corpus of cells in terms of behavioral intent as a function of time.

9. The method of claim 8 further comprising providing an extensible syntax or language to represent and make comparisons at a variety between SAU's “pull” force and the information key's “push force.”

10. The method of claim 9 further comprising generating a list of best matches between a context in which a client is placed and a plurality of possible information to be delivered to the client, including assigning scores, values, and refinements to an initial list of best matches.

11. The method of claim 10 further comprising refining the list of best matches based upon cognitive choice theories found in users relating to having a critical mass of lateral choices and also linking the vertical information keys.
